(19) United States
(12) Patent Application Publication
(10) Pub. No.: US 2007/0132757 A1
(43) Pub. Date: Jun. 14, 2007

(54) Constrained model composition

(76) Inventors: Tal Hassner, Tel Aviv (IL); Lihi Zelnik-Manor, La-Canada, CA (US); Ronen Ezra Basri, Rehovot (IL); George Leifman, Kiryat Ata (IL)

Correspondence Address: DANIEL J SWIRSKY, 55 REUVEN ST., BEIT SHEMESH, 99544, IL

(21) Appl. No.: 11/434,585

(22) Filed: May 16, 2006

Related U.S. Application Data
(60) Provisional application No. 60/681,052, filed on May 16, 2005.
(60) Provisional application No. 60/682,401, filed on May 19, 2005.

(51) Int. Cl. G06T 17/00

(52) U.S. Cl. 345/420

(57) ABSTRACT

A method includes combining at least two 3-D models, given the positions of the models and constraint areas of the models that should not be changed by the combination. The combining includes generating a weighted graph representation of the models at least in a transition volume and including at least a portion of the constraint areas and finding a minimum cut which separates the weighted graph into two cut graphs representing cut versions of the models.

### CROSS-REFERENCE TO RELATED APPLICATIONS

This application claims the benefit of U.S. Provisional Application Nos. 60/681,052, filed on May 16, 2005, and 60/682,401, filed on May 19, 2005, incorporated herein by reference in their entirety.

### FIELD OF THE INVENTION

The present invention relates to three-dimensional models in general and to their combination into new models in particular.

### BACKGROUND OF THE INVENTION

Computer graphics systems are becoming ubiquitous, posing a growing demand for both realistic and fictitious 3D models, which are computational representations of 3D objects. Constructing new models from scratch is a tedious process, requiring either a careful scan of real objects or the artistic skills of trained graphics experts. This process can potentially be enhanced, as more and more models become available, by reusing parts of existing models.

With current methods, however, the process of composing new models from existing ones is still laborious, requiring a user to manually segment the input models, align them, and determine where to connect their parts. Automatic segmentation tools exist, but they are largely inadequate for this task. Segmentation tools are applied to each of the input models independently, and so they often produce results that require the user to further trim the parts to eliminate undesired protrusions or to significantly extend the parts so that they can be connected properly.

### SUMMARY OF THE INVENTION

There is therefore provided, in accordance with a preferred embodiment of the present invention, a method including combining at least two 3-D models, given the positions of the models and constraint areas of the models that should not be changed by the combination.

Additionally, in accordance with a preferred embodiment of the present invention, the combining includes generating a weighted graph representation of the models, at least in a transition volume defined with respect to the positions and including at least a portion of the constraint areas, and finding a minimum cut which separates the weighted graph into two cut graphs representing cut versions of the models.

Moreover, in accordance with a preferred embodiment of the present invention, the method includes changing the models to match the graph cut versions of the models and/or stitching the cut models together.

Further, in accordance with a preferred embodiment of the present invention, the weighted graph has nodes representing voxels of volume occupied by the models, edges connecting neighboring the voxels, source and target nodes to which nodes representing voxels of the constraint areas are connected and weights associated with each edge which indicate whether the edge crosses a boundary of one of the models, crosses an intersection of the models or remains within one of the models. The weights may be defined as dist(Aᵢ,Bᵢ) which may be defined as follows:

$$dist ( {A}_{i} , {B}_{i} ) = \{ \begin{matrix}1 & i is a boundary voxel \\ \frac{1}{10 k} & i is an intersection voxel \\ \frac{1}{100 n k} & i is an empty voxel\end{matrix} \}$$

where k is the total number of intersection voxels and n is the total number of voxels.

Alternatively, in accordance with a preferred embodiment of the present invention, the weighted graph has nodes representing mesh faces of the models, edges at least connecting faces which share sides, intersecting edges connecting nodes representing faces of the models which intersect, source and target nodes to which nodes representing mesh faces of the constraint areas are connected and weights associated with each edge which indicate whether or not the edge is an intersecting edge.

Still further, in accordance with a preferred embodiment of the present invention, the method includes manual alignment of the two models via a graphical user interface.

There is also provided, in accordance with a preferred embodiment of the present invention, a method for aligning at least two 3D models. The method includes aligning a portion of a first model with a portion of a second model. The assigning may include assigning higher weights to the portions than to the remaining parts of the models.

There is also provided, in accordance with a preferred embodiment of the present invention, a method for fixing flaws in a 3D model, the method including: searching in a database for at least a non-flawed portion of another model similar to the input model having a flawed portion, aligning the non-flawed portion to the flawed portion, generating constraints from a transition volume around the aligned portions, generating a weighted graph representation at least of the aligned portions and the constraints and replacing the flawed portion with the non-flawed portion, using a minimum cut technique on the graph to define a transition between the portions.

Additionally, in accordance with a preferred embodiment of the present invention, the flaws may be broken parts of an object represented by the model, scarred parts of an object represented by the model, and/or missing parts of an object represented by the model.

There is also included, in accordance with a preferred embodiment of the present invention, a method for performing piecewise rigid deformation on a 3D model. The method includes cloning at least one part of the model to be deformed, moving the cloned part to another position, positioning the moved part with the respect to the model, receiving constraints with respect to the positioned items, generating a weighted graph representation at least of a transition volume at least of the positioned items, and creating a new model from the positioned items, using a minimum cut technique on the graph to define a transition between the items.

Finally, the present invention includes apparatus to perform the methods described herein.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a model processing tool and method, constructed and operative in accordance with a preferred embodiment of the present invention;

FIG. 2 is a schematic illustration of an alternative model processing tool and method, also constructed and operative in accordance with a preferred embodiment of the present invention;

FIG. 3 is an illustration of two possible part-in-whole alignments, useful in the methods of FIGS. 1 and 2;

FIG. 4 is a flowchart illustration of the operations of a model composing unit, forming part of the tools and methods of FIGS. 1 and 2;

FIG. 5 is a set of pictorial illustrations, useful in understanding some of the operations of FIG. 4;

FIG. 6 is a set of pictorial illustrations, useful in understanding a clipping operation of FIG. 4;

FIG. 7 is a schematic illustration of a model restoration unit using the model processing tool and method of FIGS. 1 and 2;

FIG. 8 is a schematic illustration of a model fixing unit using the model processing tool and method of FIGS. 1 and 2;

FIG. 9 is a schematic illustration of a piecewise rigid deformation performable with the model processing tool and method of FIGS. 1 and 2;

FIG. 10 is a flow chart illustration of an alternative embodiment of the model composing unit of FIG. 4; and

FIGS. 11A, 11B, 12A, 12B and 12C are schematic illustrations, useful in understanding the flow chart of FIG. 10.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that much of the manual labor required to generate complex models using current state-of-the-art processes may be automated using a novel model processing tool provided by the present invention.

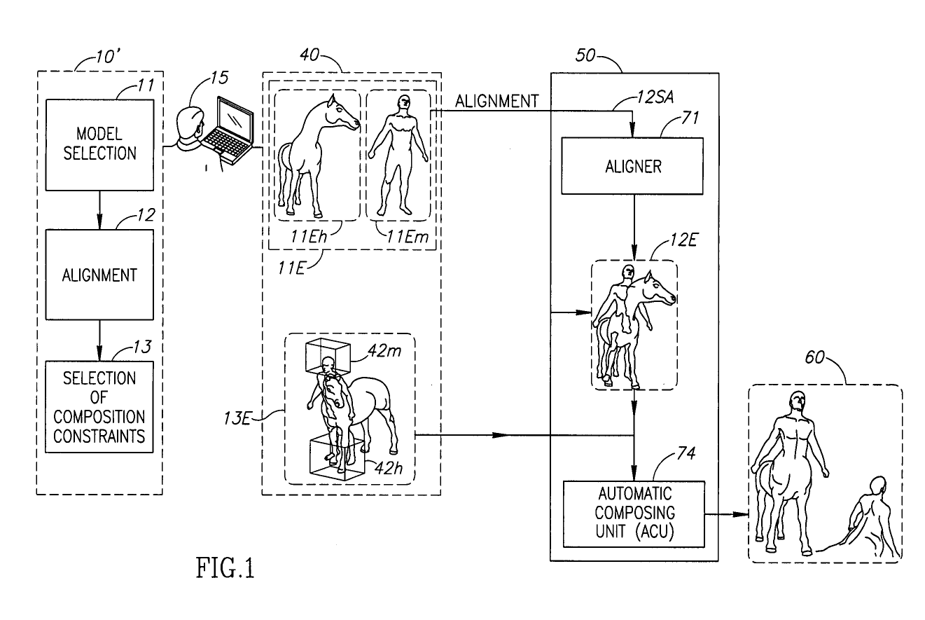

FIG. 1, reference to which is now made, illustrates how an exemplary model of a centaur may easily be constructed from component models of a horse and a man using a novel model processing tool (MPT) 50, constructed and operative in accordance with a preferred embodiment of the present invention.

As shown in a user input flow chart 10 of FIG. 1, a user 15 of MPT 50 may be required to perform three method steps, as follows: model selection (step 11), alignment (step 12), and selection (step 13) of composition constraints. MPT 50 may then process a user input 40 provided in steps 11, 12 and 13 to produce an output model 60.

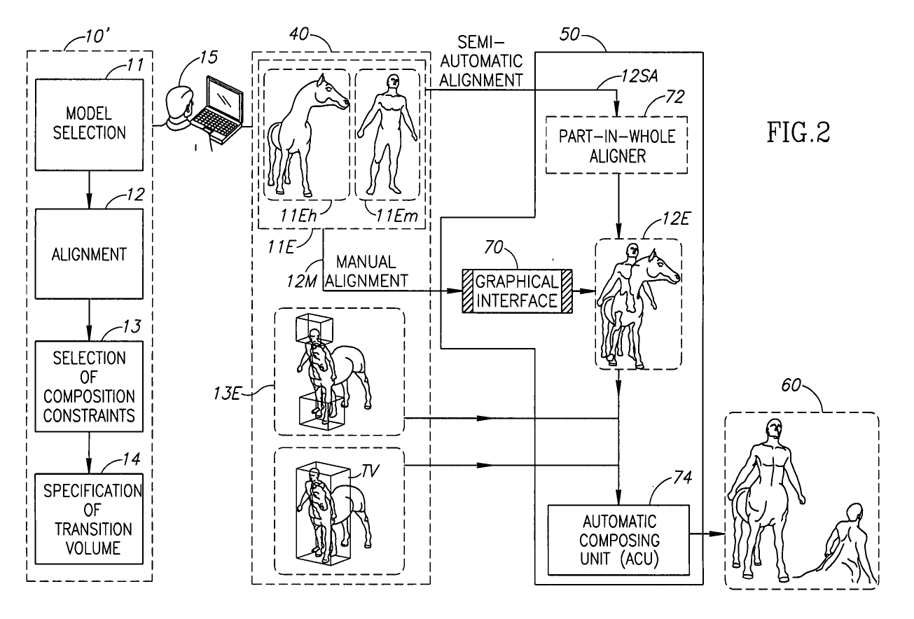

In the example shown in FIG. 1, user 15 may have desired to compose a centaur, such as that shown in exemplary output model 60. To that end, user 15 may have selected exemplary component models 11E in step 11, where one model 11Eh may be of a horse and a second model 11Em may be of a man. In step 12, alignment, user 15 may utilize an aligner 71 to define how component models 11E are to be positioned with respect to one another. As discussed in more detail hereinbelow with respect to FIG. 2, user 15 may align component models 11E manually, semi-automatically or automatically

The exemplary user-defined alignment 12E of exemplary component models 11Eh and 11Em shown in FIG. 1 shows the hips of the man of model 11Em positioned at the shoulders of the horse of model 11Eh.

After alignment, user 15 may define composition ‘constraints’ 13E in accordance with step 13 of flow chart 10. In accordance with the present invention, the composition constraints 13E may be defined as regions of each of the component models which are desired to be included in output model 60 with little or no changes. The composition constraints may be indicated by selecting cubes 42, such as exemplary cubes 42m and 42h, which contain the constraint regions, selecting a segment from a segmentation output, or even marking individual points on the model. The constraints for each input model are thus a subset of its surface and, as such, are independent of the global position of the model. It may be seen in FIG. 1 that the exemplary user-defined composition constraints 13E used to produce the centaur of exemplary output model 60 are the head of the man of model 11Em and the legs of the horse of model 11Eh, which are indicated by cubes 42m and 42h, respectively.

Once user-defined alignment 12E and composition constraints 13E for component models 11E have been provided as input to MPT 50, an automatic composing unit (ACU) 74 of MPT 50 may proceed to automatically cut models 11E and, if necessary, to stitch them into a single model.

FIG. 2 illustrates an additional preferred embodiment of the present invention, showing two alternative embodiments of aligner 71 and an alternative embodiment of the user method 10. In one embodiment, aligner 71 may be a graphical interface 70, useful for manual alignment 12M of component models 11E. Graphical interface 70 may be capable of applying rigid transformations (i.e., translation, rotation, scale and mirror) to each of component models 11E, allowing anyone with a passing knowledge of modeling software to arrange the component models as desired in a few short minutes.

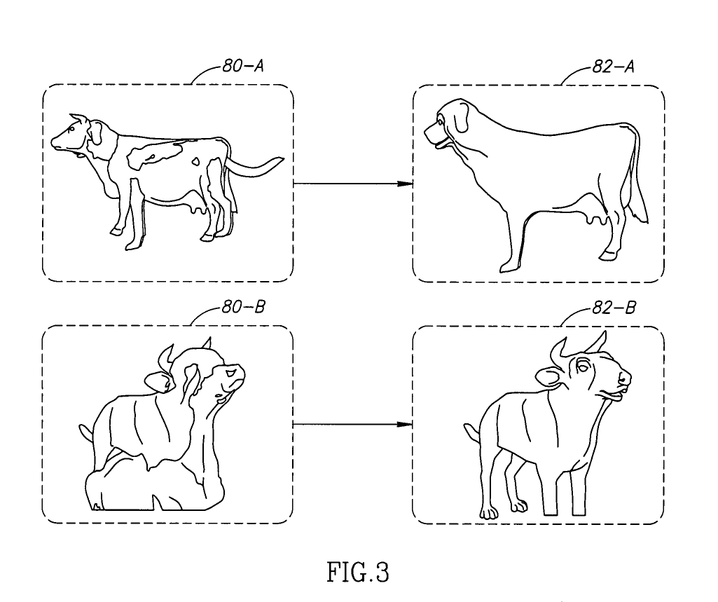

Alternatively, in accordance with the design of the present invention for both expert and novice users, alignment of component models 11E may be performed using a part-in-whole aligner 72 as shown in FIG. 2. The operation of part-in-whole aligner 72 will be discussed later in further detail with respect to FIG. 3. It will be appreciated that part-in-whole aligner 72 may also operate separately from MPT 50, in accordance with an additional preferred embodiment of the present invention.

For the embodiment of FIG. 2, an additional means may be provided to user 15 to control the final output of the model processing operation performed by MPT 50. As shown in step 14 of flow chart 10′, user 15 may further control the final output of the model processing operation performed by MPT 50 by specifying a ‘transition volume’ TV. It will be appreciated that the additional preferred embodiment of the present invention illustrated in FIG. 2 may operate in a similar manner to the embodiment of FIG. 1 with the addition of the option provided to the user to define transition volume TV.

User-defined transition volume TV may define where models 11E may connect. It will be appreciated that by default, models can connect anywhere, which is to say the default transition volume is the bounding box of the models' union. In accordance with the additional preferred embodiment of the present invention illustrated in FIG. 2, user 15 may specify a different transition volume (other than the default transition volume) by drawing an appropriate box. This user defined volume may then represent the limits within which MPT 50 may connect models 11E. As illustrated in FIG. 2, exemplary user-defined transition volume TV used to produce the centaur of exemplary output model 60 of FIGS. 1 and 2 is shown to be a box enclosing the figure of the man of model 11Em.

In accordance with the present invention, user 15 may review output model 60 produced by MPT 50 (FIGS. 1 and 2), and either accept the composition, or make changes to alignment, composition constraints or transition volume. It will be appreciated that, in accordance with the present invention, the alignment of models 11E may be revised without necessitating reselection of composition constraints 13E. Composition constraints 13E, in pertaining to the surfaces of models 11E, are unaffected by the particular positions of models 11E. This feature of the present invention may allow quick review of various model arrangements.

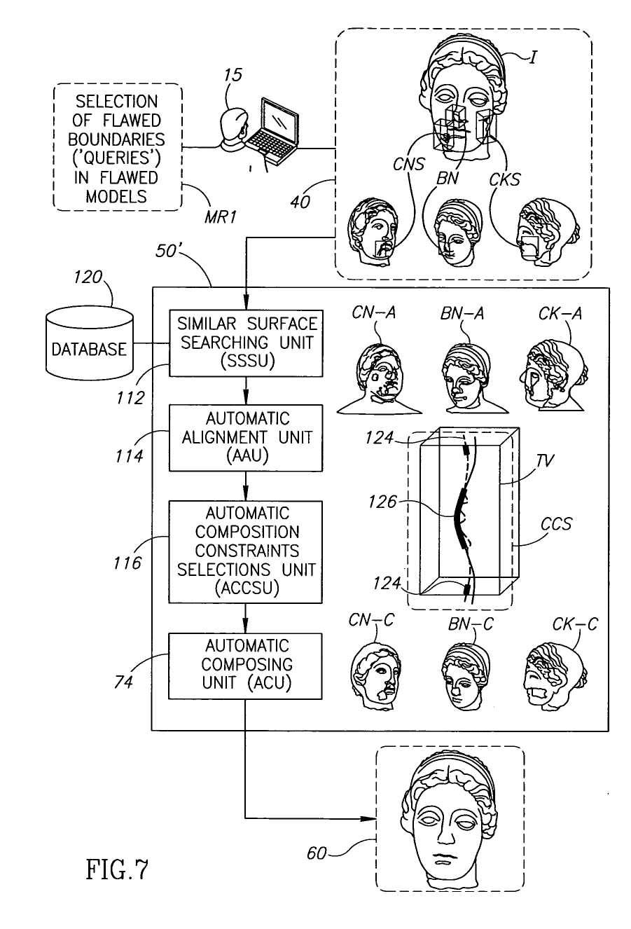

It will further be appreciated that the interface provided by the present invention is trivial, requiring only a few intuitive boxes to be roughly drawn around parts of component models 11E. Consequentially, the tool provided by the present invention may be easily automated, opening up the possibility of using it for a variety of applications, the details of which will be discussed later with respect to FIGS. 7, 8 and 9.

Reference is now made to FIG. 3, which is helpful in understanding the operation of part-in-whole aligner 72. Applicants have realized that most work on alignment in the prior art is based on searching for an optimal alignment of complete models, as in Pauly et al., [“Shape modeling with point-sampled geometry” In Proc. of SIGGRAPH ACM, 2003]. However, Applicants have realized that for the purpose of model processing, this approach may often be inappropriate. For example, aligning models 11Eh and 11Em of FIGS. 1 and 2 in this manner may place the man horizontally along the horse's back.

Aligner 72 may, instead, search for the optimal, or close to optimal, “part-in-whole” alignment of input models 11E. The part-in-whole alignment may be defined as an alignment of “emphasized” parts of models, as illustrated in FIG. 3. Alternatively, part-in-whole aligner 72 may align sub-parts.

FIG. 3 shows the results of two different part-in-whole alignments. Alignment illustration 80-A shows the positions in which an exemplary model of a cow and an exemplary model of a dog may be aligned at their torsos. As a result the bodies of the models are aligned body-to-body. Alignment illustration 80-B shows the models of a cow and a dog aligned at their heads.

FIG. 3 further illustrates the difference between the resulting output models 60 (FIGS. 1 and 2) of the model processing operation provided by the present invention, for exemplary alignments 80-A and 80-B. As shown in FIG. 3, exemplary composition result 82-A is the output model of the model processing operation provided by the present invention when user-defined alignment 12E (FIGS. 1 and 2) is exemplary alignment 80-A. Exemplary composition result 82-B is the output model of the model processing operation provided by the present invention when user-defined alignment 12E is exemplary alignment 80-B. As illustrated in FIG. 3, models aligned using the part-in-whole approach may share overlapping surfaces in the parts selected for primary alignment, which may then be smoothly connected, and no or little overlapping in the non-selected parts.

Unlike other alignment methods proposed in computer vision which use mostly feature points and lines, the present invention may utilize segmentation as an aid as in Kanai et al. [Interactive mesh fusion based on local 3d metamorphosis. Graphics Interface, 1999]. This segmentation may be manual or automatic. All that is required of user 15 may be selection of the emphasized parts. Part-in-whole aligner 72 may then align the input models, in their entireties, automatically. For the actual part-to-part alignment algorithm, the present invention may utilize PCA, as in Hoffmann et al. [Geometric and Solid Modeling: An Introduction. Morgan Kaufmann, 1989] to obtain a coarse guess for the rigid transformation between the selected parts. Standard ICP, as in Pauly et al., may then be used to refine the guess and recover the final part-to-part alignment.

Areas to be aligned may be marked and weights may be provided to the elements of the model within the parts or sub-parts. In one embodiment, elements of parts to be aligned may be assigned a weight of 1 while the remaining elements of the model may be assigned a weight of 0. Alternatively, other weights, generally varying from 0 to 1, may be assigned. In one embodiment, the value of the weight may be a function of its distance from a centroid of the part to be aligned. For all embodiments, once the weights have been assigned, aligner 72 may attempt to align the models by minimizing a cost function associated with the weights.

Once the two models have been aligned, model processing tool 50 may join the two models. Applicants have realized that graph theory may be utilized to smoothly join the two models in transition volume TV in the alignment area.

Graph theory describes systems as a series of nodes connected together with edges in a graph, where each edge has a weight defining the relationship of the two connected nodes. For example, a map may be defined as a series of cities (the nodes) connected together by roads (the edges). For such a graph, the weight of the edge may define the distance between the cities or the time it takes to travel between the cities, etc. In the present invention, the nodes may be elements of the models and the edges may define which nodes neighbor each other. The weights may define how the elements overlap each other in the transition volume.

Applicants have also realized that a “minimal cut/maximal flow” method of graph theory may be utilized to define a transition from one model to the next in the transition volume. The process determines the maximal flow through the graph from a predetermined source node to a pre-determined target node and the areas where there are bottlenecks to said maximal flow. Applicants have realized that the bottleneck areas (also known as the “minimal cut”) may define the smoothest transition surface from one model to the next.

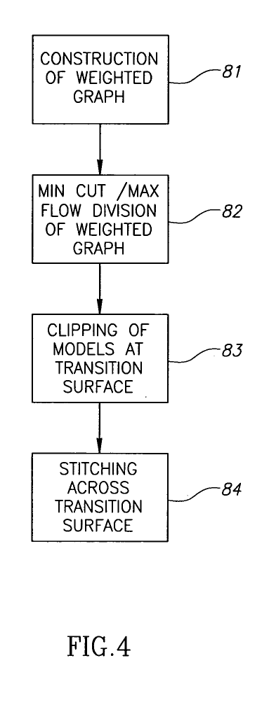

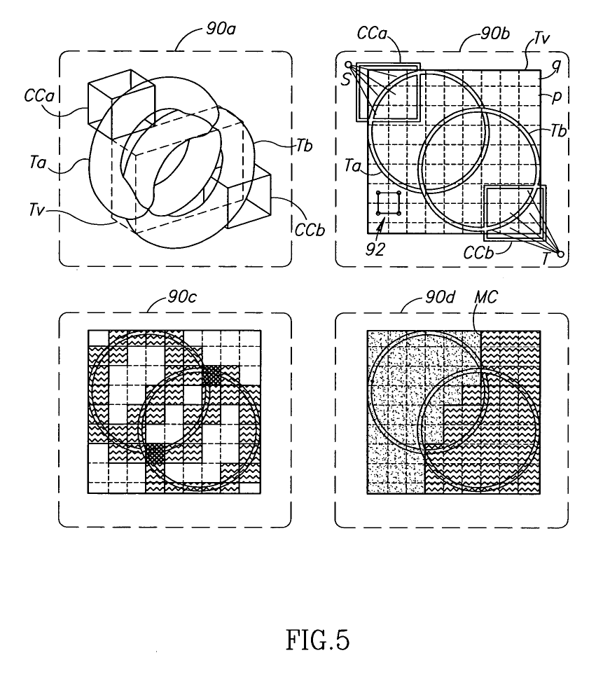

Reference is now made to FIG. 4, which is a flow chart illustration of the operation of ACU 74 in accordance with the present invention. As discussed hereinabove and as shown in FIG. 4, the first step of the automatic composing process, step 81, may be the construction of a weighted graph, discussed hereinbelow with respect to FIG. 5, representing the two models in the transition volume. This may require converting from the original format of the model to one more conducive for defining as a graph. For example, some standard representations are by meshes (which describe the 3D surface of the object with connected polyhedrons, such as triangles), voxels (which are cubes which define a sampling of the 3D space which the object occupies), surfels (which represent the surface with discs or “point clouds”), etc.

In the second step of the process, step 82, the weighted graph may be divided using the “minimal cut/maximal flow” method of graph theory, also discussed hereinbelow with respect to FIG. 5. The graph cut may define the transition from one model to the next. For the exemplary voxel representation discussed herein, the graph cut may represent a surface separating the transition volume into disjoint sub-volumes. In accordance with the present invention, this surface may be defined as a ‘transition surface’, as it determines where the models should be cut and, if necessary, stitched, or rather, where the transition from one model to the other occurs. The weights associated with each edge in the graph ensure that this surface passes where the models are closest and most similar, which in return ensures that the resulting composition will be smooth.

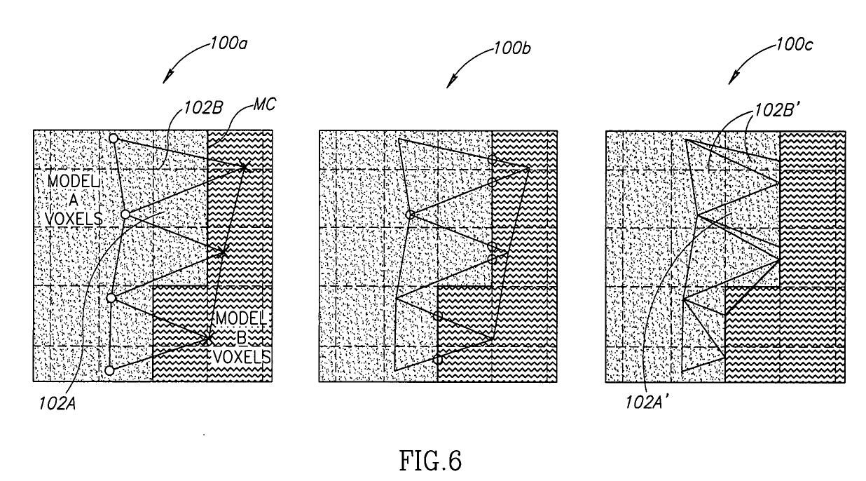

In the third step of the process, step 83, the models may be clipped at the transition surface, as discussed hereinbelow with respect to FIG. 6. In an optional fourth step of the process, step 84, the models may be stitched at the transition surface, as discussed hereinbelow and as is known in the art. The final step, of stitching the models across the transition surface, may produce the final result of the model processing operation provided by the present invention. Returning now briefly to FIG. 1, it may be seen that the final result of the exemplary model processing operation illustrated in FIG. 1, i.e. exemplary output model 60, which, in this example, is a model of a centaur.

Reference is now made to FIG. 5 which provides further details of the operation of ACU 74. The first task performed by ACU 74 may be to convert the model from its current format to one more conducive to describing in graph form. For example, if the model is in mesh format, ACU 74 may voxelize the object within the mesh. ACU 74 may then run an optimization procedure to find the best location for a transition between input models 11E, on each of the input models (within the transition volume). As illustrated in step 81 of FIG. 4, this optimization procedure may be implemented by constructing a weighted graph G=(V, E), with nodes in V representing voxels, edges in E indicating which voxels are neighbors, and weights associated with the edges, expressing the (inverse) likelihood of transitions (i.e., low cost implies smooth transition from one model to another). Auxiliary source and target nodes S and T, representing a first model, “model A” and a second model, “model B”, respectively, may be added to this graph and may be connected to the constrained regions in each model.

Returning now to the weighted graph of method step 81 of FIG. 4, it will be appreciated that there are several ways in which an automatic, graph-based composing scheme may be implemented. In the present invention, Applicants have implemented the simple approach illustrated in FIG. 5. In the example shown in FIG. 5 which illustrates the method steps of weighted graph construction (step 81 of FIG. 4) and the minimal cut (step 82 of FIG. 4) the two input models are torus Ta and torus Tb, as shown in illustration 90a. Illustration 90a further shows the user-selected composition constraints CCa and CCb for the model processing operation, and transition volume TV, the bounding box of the union of input models Ta and Tb.

In accordance with the present invention, the first step in the construction of the weighted graph may be a joint 3-D rasterization of the boundaries of the models within the transition volume. Each voxel (a very small cube of the model) in the joint rasterization may be represented by a node in the graph, and two neighboring voxels p and q may be connected by an edge.

Illustration 90b in FIG. 5 shows a representation of the joint rasterization of models Ta and Th displayed as a simplified 2D sketch. Exemplary neighboring voxels p and q are shown, as are the boundaries Ta and Th of models A and B, respectively. Illustration 90bfurther shows parts of the weighted graph, here labeled 92, that is associated with the voxels of transition volume TV. The center of each voxel is defined as a node and each edge connects the two neighboring nodes. The nodes associated with the voxels of a surface constrained by a composition constraint 13E (FIGS. 1 and 3) may be connected, in the weighted graph, to one of the special nodes, where the nodes associated with the voxels of model Ta may be connected to the source S and the nodes associated with the voxels of model Tb may be connected to the target T. It may be seen in illustration 90b that the constrained faces of models Ta and Tb are the sections of models Ta and Tb which are located in composition constraint volumes CCa and CCb respectively.

Edges connected to either source S or target T may be assigned infinite weights as they may not be cut. Otherwise, the weight w(p,q) associated with an edge connecting nodes p and q may be defined as given in equation Eq1:
w(p,q)=min{dist(Aₚ,Bₚ),dist(A_{q},B_{q})}, (Eq1)

where Aᵢ and Bᵢ represent the portions of the surfaces of models Ta and Tb respectively, in voxel i, and dist(Aᵢ,Bᵢ) measures the distance between them.

It will be appreciated that the notion of a best place to connect two models is captured by the choice of a function dist(Aᵢ,Bᵢ). Applicants have realized that different functions reflect different user preferences for a best transition location (e.g., based on local surface curvature, texture etc.). Applicants have further found that the function discussed hereinbelow may be particularly useful in the present invention.

Intuitively, a location to cut and stitch the input models may be sought where the least amount of “glue” may be needed to connect them. Specifically, an attempt may be made to cut the two models where they are closest (approximately intersecting), while at the same time minimizing the cut itself. To this end, three types of voxels may be considered. The first type of voxel, the boundary voxel, may contain a boundary of only one of the two input models. The second type of voxel, the empty voxel, may contain no boundary at all. The third type of voxel, the intersection voxel, may contain boundaries from both input models. In illustration 90c of FIG. 5, the three different types of voxels are indicated using distinctive hatching patterns. Empty voxels are unhatched, boundary voxels are indicated with a wave hatching pattern, and intersection voxels are indicated by a diamond hatching pattern.

A smooth cut may connect the two input models approximately through their intersection and avoid cutting where only one surface passes. Therefore, large distance values may be assigned to boundary voxels and small distance values may be assigned to intersection voxels. Moreover, intersection voxel distance values may be chosen such that the accumulative distance of all intersection voxels may still be smaller than the distance assigned to a single boundary voxel. Since it may be preferable not to cut any boundary at all, an even smaller distance may be assigned to empty voxels such that the accumulative distance of all the empty voxels may be smaller than any intersection voxel. Therefore, the assignment of values in the present invention may be given as:

$$dist ( {A}_{i} , {B}_{i} ) = \{ \begin{matrix}1 & i is a boundary voxel \\ \frac{1}{10 k} & i is an intersection voxel \\ \frac{1}{100 nk} & i is an empty voxel\end{matrix} \} \qquad ( Eq 2 )$$

where k is the total number of intersection voxels and n is the total number of voxels.

A minimal cut may provide a partition of the voxels into those labeled “Model A” (i.e. those connected to source S after the cut) and those labeled “Model B” (i.e. those connected to target T after the cut). The composition result for the model processing operation provided by the present invention may contain those parts of the boundary of model A located in “Model A” labeled voxels, and similarly parts of model B in “Model B” labeled voxels. This feature of the minimal cut is illustrated in illustration 90d of FIG. 5 where partition line MC, representing the minimal cut line, separates “Model Ta” labeled voxels, designated by a dotted hatching pattern, from “Model Tb” labeled voxels, designated by a zigzag hatching pattern. It is thus guaranteed that the composition result may contain no self intersecting surfaces, as long as there were none in the original input models. A cut may be defined as minimal if the sum of all weights w(p, q) for all nodes p and q separated by the cut, is minimal.

The best transition may then be found by computing the minimal cut in the graph (using a max flow algorithm). The computation of the minimal cut in the graph may be the second step (step 82) performed by ACU 74, as illustrated in FIG. 4.

Computing a minimal cut is known in the prior art to have polynomial time worst case algorithms, such as the Ford and Fulkerson type methods of Decaudin [Geometric deformation by merging a 3d object with a simple shape. “Proc. of Graphics Interface”, 1996]. Recently, Boykov et. al [“An experimental comparison of min-cut/max-flow algorithms for energy minimization in computer vision” EMMCVPR, 2001] have developed a variant of these methods which has been shown to have linear running time in practice for regular lattice graphs. This has made this method popular in applications involving images and video. This algorithm may be implemented in the present invention.

At this point, minimal cut MC may be defined for the voxel representations of models A and B. However, that is not the desired representation for the final, joined model. To that end, the original representations of models A and B may be “clipped” (step 83) to approximately match the shape defined by minimal cut MC.

Applicants have realized that an improvement to the Zippering method of Turk et al. [Zippered polygon meshes from range images. In Proc. of SIGGRAPH. ACM, 1994] may be employed for the clipping, for models originally represented as meshes.

In the present invention, both meshes may not be clipped against each other, but rather against minimal cut MC. As minimal cut MC passes where the two models are closest (approximately intersecting), it may be guaranteed that meshes clipped against it will have tightly matching borders.

Reference is now made to FIG. 6 in which the clipping procedure provided by the present invention in accordance with step 83 of FIG. 4 is illustrated. Illustration 100a in FIG. 6 shows mesh faces 102 of the border of mesh A where they cross minimal cut MC. A face belonging to mesh A may be defined as a border face if it contains at least one vertex in a voxel labeled A (an ‘inside vertex’) and at least one in a voxel labeled B (an ‘outside vertex’). In illustration 100a, voxels labeled A (model A voxels) are indicated by a dotted hatching pattern, and voxels labeled B (model B voxels) are indicated by a zigzag hatching pattern. For the border faces of mesh A shown in illustration 100a, inside vertices are designated with circles, and outside vertices are designated with “X”s.

In accordance with the present invention, all border faces of a mesh may be clipped by traversing edges leading from inside to outside vertices. This may be done by employing the fast, integer based voxel traversal algorithm of Cohen [Voxel traversal along a 3d line. Graphics gems IV, pages 366-369, 1994.] The traversal may terminate once a voxel label changes (i.e., when the traversal along the face edge crosses minimal cut MC). The mesh edge may then be moved to the side of the voxel last passed through in the traversal. In illustration 100b, the new end vertices on minimal cut MC are indicated by circles. Border faces having only one inside vertex, such as face 102A, may thus be cropped by replacing their outside vertices with new end vertices on the transition surface, generating a new face 102A′, as shown in illustration 100c. Border faces having two inside vertices, such as face 102B, may produce tetrahedrons which may then be triangulated to produce two new triangles 102B′, as shown in illustration 100c. This procedure may then be repeated for model B.

In accordance with the flow chart illustration of FIG. 4, once the two meshes have been clipped (step 83), as described hereinabove with respect to FIG. 6, the two meshes may be stitched into a single model (step 84). Stitching may be accomplished using any standard method (e.g., Kanai et al., Interactive mesh fusion based on local 3d metamorphosis. In Graphics Interface, 1999, or Yu et al., Mesh editing with poison-based gradient field manipulation. In Proc. Of SIGGRAPH. ACM, 2004).

In fact, as the two models share close matching borders, achieved with the clipping method provided by the present invention, even a simple method of stitching would most likely do well. The stitching method described hereinbelow, used in Funkhouser et al. [Modeling by example. In Proc. of SIGGRAPH. ACM, 2004], based on Kanai et al., may be employed in the present invention.

In the stitching method employed in the present invention C_{A} and C_{B} are defined as two matching border contours of the two models A and B. Two vertices n_{A} and n_{B} are selected, one from C_{A} and the other from C_{B}, which are the closest of all such pairs. n′_{A} is then defined to be the vertex 10% of the way around C_{A} starting at n_{A}, and n_{B} is similarly defined on C_{B}. The dot product of the two vectors, one from n_{A} to n′_{A} and the other from n_{B}to n′_{B} , indicates the orientation around C_{A} and C_{B}. Vertex correspondences are then set between C_{A} and C_{B} iteratively. Starting at n_{A} and n_{B} and proceeding along the curve for which the next vertex is closest, vertices are matched by adding edges between them, creating new faces for the mesh. Once the gap between the two models is thus sealed, the user may further smooth the new boundary by averaging vertex positions by their neighbors in a user-specified number of iterations, applied to vertices at a distance no larger than a user specified threshold, using user-defined weights.

In an alternative embodiment of the present invention, the weighted graph may be constructed (step 81 of FIG. 4) directly from the mesh representations of the models, rather than from the voxel representations.

In this embodiment, the weighted graph may be created from those portions of the meshes found within transition volume TV. Mesh vertices found within composition constraint surfaces CCS may be connected to source S and target T and those vertices of one model which are very close to vertices of the second model may be connected together to generate a single graph.

The resultant minimal cut MC (step 82) may divide the graph into two new models against which the original models may need to be clipped. The clipped meshes may then be stitched together.

It will be appreciated that, owing to the trivial interface of the model processing system provided by the present invention, it may be easily automated to a significant extent, and applied as a unified solution to a variety of model processing tasks. The application of the present invention in the modeling tasks of model restoration, hole filling, and model deformations is illustrated in FIGS. 7, 8 and 9, respectively, reference to which is now made.

The model processing system provided by the present invention may provide a modeler with easy means of repairing flawed models (e.g., scarred models) by replacing the defective boundary patches of a flawed model with perfect surfaces obtained from a model database. This is illustrated in FIG. 7 which shows an exemplary restoration of the broken nose, cheek scar and chin scar of the Igea model.

It will be appreciated that the system illustrated in FIG. 7 is an additional preferred embodiment of the present invention illustrated in FIGS. 1 and 2. In the embodiments of the present invention of FIGS. 1 and 2, three (FIG. 1) or four (FIG. 2) method steps may be required of user 15 as illustrated in flow charts 10 and 10′ of FIGS. 1 and 2 respectively. It will be appreciated that, in comparison, the involvement of user 15 in the model restoration process of FIG. 7 may be reduced to a single method step MR1. In the embodiment of the present invention illustrated in FIG. 7, method step MR1 may require only the selection of one or more flawed boundaries (each flawed boundary comprising a ‘query’) of the flawed model by drawing a box around each one. The steps of alignment (user 15 method step 12 in FIGS. 1 and 2) and selection of constraints for determining the composition of output model 60 (user 15 method step 13 in FIG. 1, and steps 13 and 14 in FIG. 2) may be performed automatically by a model processing tool 50′ as discussed in further detail hereinbelow.

As shown in FIG. 7, model processing tool 50′ may comprise a similar surface searching unit (SSSU) 112, an automatic alignment unit (AAU) 114, an automatic composition constraints selection unit (ACCSU) 116, and ACU 74. It will be appreciated that ASCU 74 of FIG. 7 may operate in a manner similar to ACU 74 of FIGS. 1 and 3. SSSU 112 may conduct searches in database 120 for surfaces most similar to the ones selected by user 15 in method step MR1. The operation of SSSU 112 will be discussed in further detail hereinbelow.

Exemplary user input 40 in FIG. 7 shows that the flawed boundaries selected by user 15 are broken nose BN, chin scar CNS and cheek scar CKS of model I. In accordance with the present invention, and as illustrated in FIG. 7, user 15 may select flawed boundaries of a flawed model by drawing boxes around them.

As shown in FIG. 7, SSSU 112 of MPT 50′ may then search database 120 of models for surfaces most similar to the ones selected by user 15. In accordance with the present invention, SSSU 112 may search database 120 for the best fitting surface patch in progressively finer and finer resolutions. Resolution defaults may be set for the whole database in advance and may not require changing from one query to the next. At each resolution both the query surface and each database model may be rasterized. Then a search, using the weighted sum of squared distances, for the sub-volume most similar to the query volume may be performed. Weights may equal the number of occupied voxels in each search site.

From one scale to the next, the search may be limited in two ways. First, half the models searched in the previous scale, for which the best score was lowest, may be removed. Second, searching finer scales may be performed only in the area of the best match from the previous coarse scale. A best match surface patch may then be selected.

AAU 114 may then automatically align the best match surface patches recovered from database 120 by translating model I in order to align the position of each recovered best match surface patch with the position of its respective query. Part-in-whole alignment, described hereinabove with respect to FIG. 3, may be used to refine the surface to surface alignment, taking the query and the recovered database surface as emphasized parts. Exemplary alignment illustrations CN-A, BN-A and CK-A in FIG. 7 show the alignment of input model I with recovered database patches for the chin, nose and cheek restoration (respectively) of input model I. The input model portions of alignment illustrations CN-A, BN-A and CK-A are shown in dark grey, while the recovered database patch portions are shown in a lighter shade of grey.

Following alignment, ACCSU 116 may automate the selection of composition constraints to control how the aligned figures of the input model and the recovered database patches (e.g., CN-A, BN-A and CK-A) will be cut and stitched by ACU 74 to yield output model 60. Firstly, each user drawn box around a flaw may be defined to be a transition volume TV, as illustrated in diagram CCS of FIG. 7, which shows one exemplary user drawn box around one exemplary flaw in model I. It may then be assumed that the flaw in the input model is roughly at the center of the user drawn box (i.e., the center of the query). Constraints on the flawed model may therefore be automatically selected to be mesh faces furthest from the flaw, i.e., mesh faces closest to the sides of the transition volume. Constraints on the database model chosen to repair the flaw may be selected closest to the flaw, in other words, closest to the center of the transition volume.

These automatic choices of constraints, as performed by ACSSU 116, are illustrated in diagram CCS where the query surface, i.e. the flawed surface of the Igea model, is represented by a dashed line, and the database patch surface is represented by a solid line. The automatic choices for the query constraints (i.e., the constraints on the flawed input model) are the mesh faces closest to the transition volume sides, indicated by the thick sections 124 of the dashed line representing the query surface. The automatic choice for the constraint on the database model, as indicated by the thick section 126 of the solid line, is closest to the center of transition volume TV. It will be appreciated that the actual distances of the constraint limits from the center of the transition volume and its sides may be governed by a user defined parameter.

As described hereinabove with respect to FIGS. 1 and 2, ACU 74 may proceed to automatically cut and stitch the two models once their relative alignment positions and composition constraints have been selected. The operation of ACU 74 of FIG. 7 may be similar to the operation of ACU 74 described hereinabove. Returning now to FIG. 7, the cutting and stitching performed by ACU 74 on the aligned models shown in CN-A, BN-A and CK-A is shown to yield clipped models CN-C, BN-C and CK-C in which the flawed chin, nose and cheek, respectively, of model I have been repaired. All three repairs are shown in output model 60.

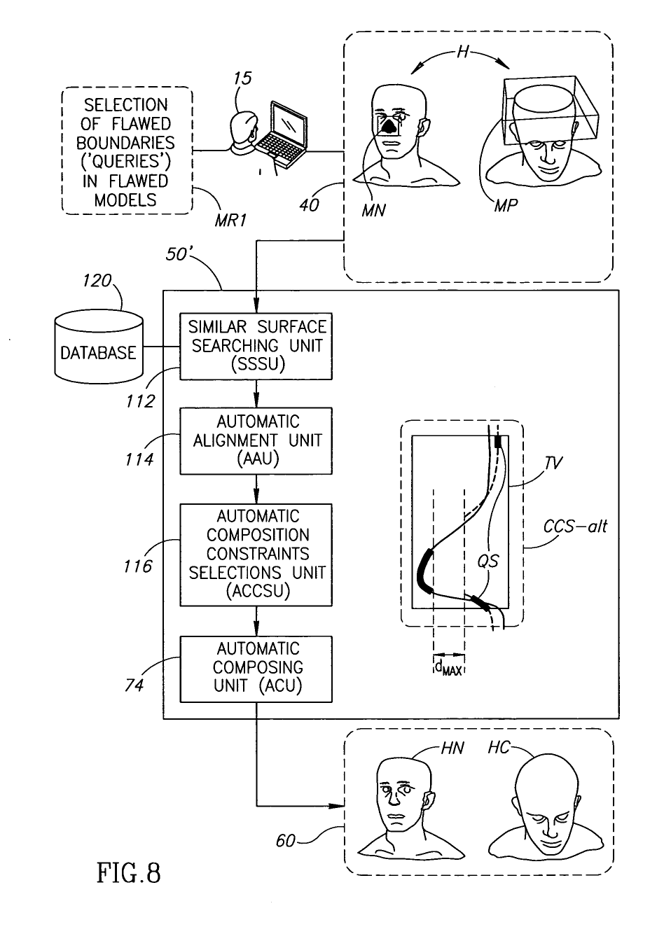

Reference is now made to FIG. 8 which illustrates how the present invention may be employed in a hole filling application. Holes in meshes are a common phenomena, often produced as a result of using 3D range scanners. Hole filling may be accomplished by an additional preferred embodiment of the present invention, illustrated in FIG. 8, which may be similar to the embodiment of the present invention illustrated in FIG. 7, but wherein an alternative composition constraints selection method may be employed.

As in the embodiment of FIG. 7, the one method step required of user 15 in the embodiment of FIG. 8 is the selection of the flawed boundaries in the input model, which may, as in the embodiment of FIG. 7, be designated by user 15 by drawing boxes around them. This is illustrated in FIG. 8 where the missing nose MN and missing crown MP of model H are designated by boxes in user input 40. The system then attempts to fill the hole using complete models from database 120.

In hole filling applications, unlike model restoration, additional information about the model selected by the user is known, i.e. that parts of it are missing. Therefore, while the processes performed by SSSU 112 and AAU 114 of MPT 50′ may be similar for model restoration and hole filling applications (though in hole filling application, SSSU 112 may search for shapes whose boundaries match the shape of the hole), the composition constraints selection process performed by ACCSU 116 for hole filling applications may be performed in accordance with a different method than that used for model restoration applications. This alternative method is described hereinbelow with respect to diagram CCS-alt in FIG. 8.

As in the embodiment of FIG. 7, each user-drawn box around a hole in the embodiment of FIG. 8 may be defined to be a transition volume TV, as illustrated in diagram CCS-alt of. It may also be assumed, as in the embodiment of FIG. 7, that the hole in the input model is roughly at the center of the user drawn box (i.e., the center of the query). Again, as in the embodiment of FIG. 7, constraints on the flawed model may be automatically selected to be the mesh faces furthest from the hole, i.e., the faces closest to the sides of transition volume TV. However, unlike in the embodiment of FIG. 7, constraints on the database model chosen to repair the hole may be the mesh faces furthest from the query surface, rather than the mesh faces closest to the center of the transition volume.

In diagram CCS-alt, the query surface which contains a hole in the place where a nose should be is represented by a dashed line, and the database patch surface is represented by a solid line. As in diagram CCS of FIG. 7, the automatic choices of ACCSU 116 for the query constraints (i.e., the constraints on the flawed input model) are the mesh faces closest to the transition volume sides, where the dashed line is thick. However, unlike diagram CCS of FIG. 7, diagram CCS-alt of FIG. 8 shows that the automatic choice of ACCSU 116 for the constraint on the database model is the section of the database patch surface (solid line) which is farthest from the query surface (dashed line). This section is indicated by a thick solid line, and is shown in diagram CCS-alt to be a maximum distance, d_{MAX}, from the query surface QS.

Selection of mesh faces for constraint selection may be performed by calculating the discrete distance transform, D_{Q}, of query surface QS within transition volume TV. The binary rasterization, R_{S}, of the selected database surface may then be obtained. The component wise multiplication of D_{Q} and R_{S} may provide an estimate of the distance of each mesh face in the database model from the query surface. Then, mesh faces passing through voxels whose distance is larger then a user-specified distance may be chosen as constraints.

Output models 60 of the exemplary hole filling process illustrated in FIG. 8 show model H with a repaired nose and crown in illustrations HN and HC respectively.

In practice, user 15 may choose between the two methods of constraining the database surface, i.e., the methods described with respect to diagrams CCS and CCS-alt in FIGS. 7 and 8 respectively, depending on the application.

Applicants have realized that the present invention may also provide a simple, “quick and dirty” method for applying piecewise rigid deformations to models and for generating simple 3D animations. In the straightforward approach to model deformation provided by the present invention, a model may be cloned, after which user 15 may change the position of the cloned model with respect to the original model (i.e., by applying rotation, translation etc.). Then, ACU 74 may automatically cut and stitch the two models, producing the desired deformation.

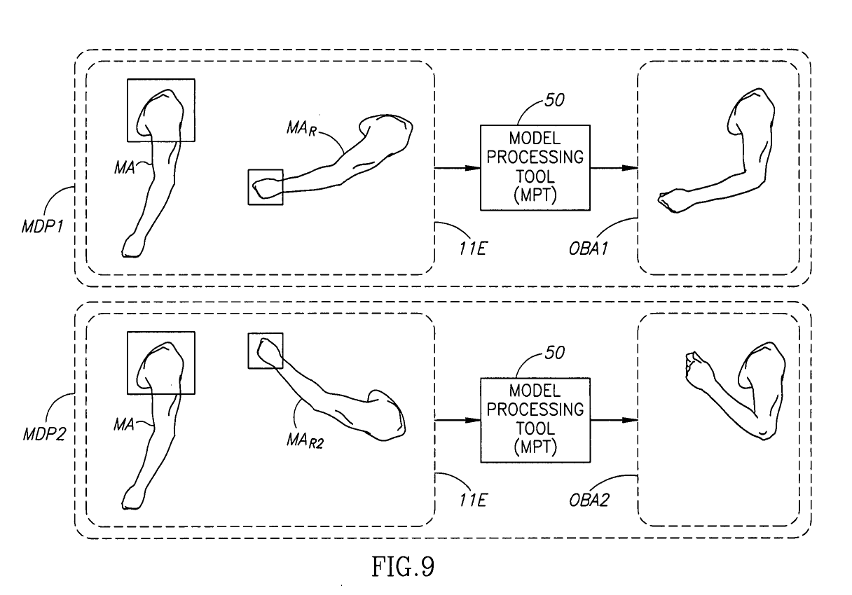

FIG. 9, reference to which is now made, illustrates two processes of model deformation, MDP1 and MDP2, performed in accordance with an additional preferred embodiment of the present invention. The exemplary model used in both processes is arm MA. In model deformation process MDP1, as shown in FIG. 9, arm MA is cloned and rotated to a new position. Then arm MA, and the rotated clone of arm MA, arm MA_{R}, serve as input models 11E to model processing tool 50. Similarly, in model deformation process MDP2, input models 11E are shown to be arm MA and arm MA_{R2}, a clone of arm MA rotated further from the original position of arm MA than arm MA_{R}.

The user may then need only to choose the shoulder of arm MA, and the hand of arms MA_{R} and MA_{R2}, (for processes MDP1 and MDP2 respectively) as composition constraints in order to create bent arm models. Boxes shown in FIG. 9 around the shoulder of arm MA and the hand of arm MA_{R} indicate user selection of these features as composition constraints for process MDP1. Similarly, boxes shown in FIG. 9 around the shoulder of arm MA and the hand of arm MA_{R2} indicate user selection of these features as composition constraints for process MDP2. Output model results OBA1 and OBA2 (for processes MDP1 and MDP2 respectively) of arms bent at different angles are also shown in FIG. 9.

It will be appreciated that once constraints are selected, there may be no need to reselect them for subsequent deformations. The present invention may thereby allow the quick creation of deformed models such as arms bent at different angles, or heads looking in different directions. While the prior art may provide more sophisticated methods for model deformation, the system and method provided by the present invention may allow even unskilled users to easily deform models.

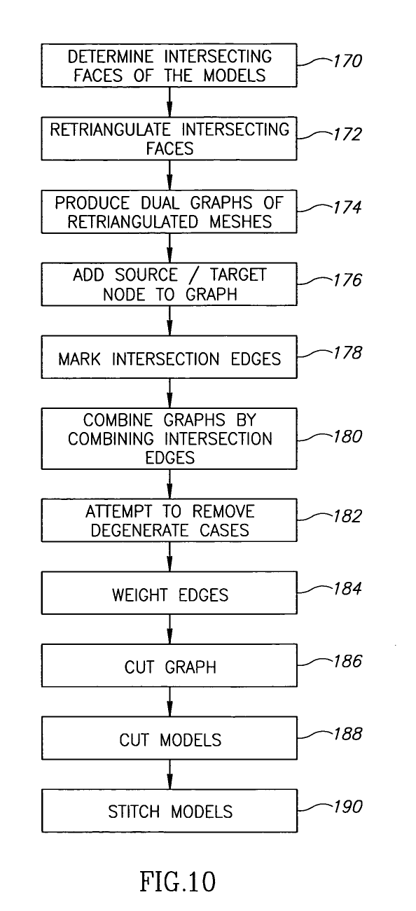

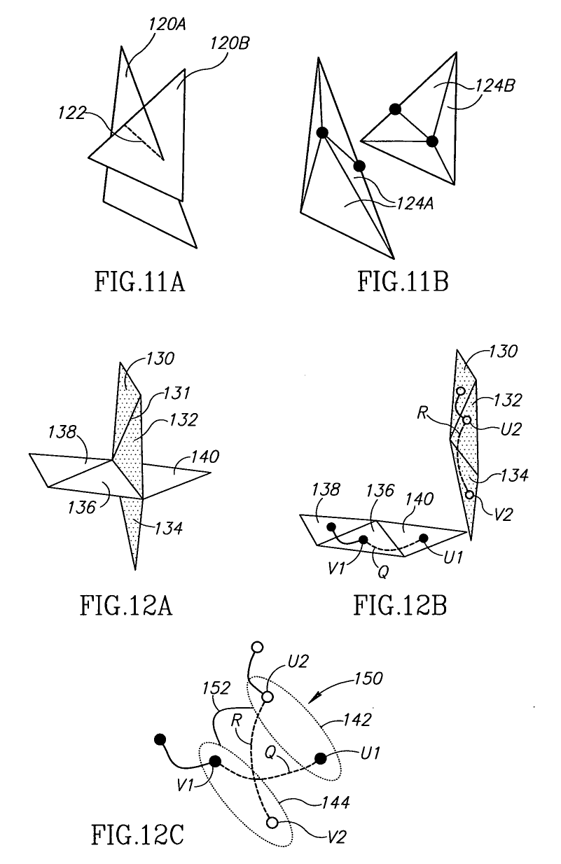

Reference is now made to FIG. 10, which illustrates an alternative embodiment of the operations of automatic composing unit (ACU) 74. Reference is also made to FIGS. 11 and 12 which, together, illustrates aspects of the method of FIG. 10. In this embodiment, the voxel representation is not utilized. Instead, the weighted graph is built from the mesh representations of the models.

Initially (step 170), the method may determine the intersections between mesh faces of models A and B, using standard methods. This is illustrated in FIG. 11A, which shows two intersecting mesh faces 120A and 120B and a dashed line 122 which marks their intersection. As shown in FIG. 11B, intersected faces 120 may be broken along intersection line 122 and then re-triangulated (172), generating new faces 124, to maintain each model as a legal triangulated mesh.

Once the intersecting faces have been re-triangulated, unit 74 may produce (step 174) a “dual graph” of each model's mesh, where each node may represent a mesh face. Two such nodes may be connected by an edge if the mesh faces they represent originally shared a side. This is shown in FIG. 12. In FIG. 12A, model A (shown hatched) has three faces 130, 132 and 134 as does model B (faces 136, 138 and 140). Faces 130 and 132 share a side 131. Faces 132 and 134 of model A intersect with faces 136 and 140 of model B while faces 130 of model A and 138 of model B do not intersect. As shown in FIG. 12B, node v1 represents face 136. Node u2 represents face 140 and is connected to node v1 by an edge Q. Node v2 represents face 134. Node u2 represents face 132 and is connected to node v2 by an edge R.

In step 176, unit 74 may add a source node to the nodes of the dual graph representing model A and may add new edges connecting the source node to all nodes of the dual graph which represent faces in model A which were selected by the user as constraints. Unit 74 may perform a similar operation for model B, but with a target node.

Unit 74 may mark (step 178) “intersection edges” on the dual graphs of the models. Such an intersection edge, shown as a dashed curve in FIG. 12B, may be an edge in the dual graph of either model, connecting two of its faces across a side added above in the re-triangulation. For example, edges Q and R. Non-intersecting edges are indicated with solid curves.

Since the side is shared by both models, unit 74 may then replace (step 180) the shared side, as described hereinbelow with respect to FIGS. 12B and 12C, with single nodes. This may generate a single, combined model from the two separate models.

Both edges Q and R represent the same intersection between models A and B. Unit 74 may substitute a single node 144 for nodes v1 and v2 and a node 142 for nodes ul and u2 and may substitute a new edge 152, connecting new nodes 142 and 144, for edges Q and R. As discussed in more detail hereinbelow, there may be other ways of pairing the nodes.

In step 182, unit 74 may add or remove intersection edges to attempt to remove degenerate cases resulting from faulty user selections (e.g., constraint selection which includes intersecting faces, a transition volume which does not include the full intersection of the two models etc.)

With the graph connections finished, unit 74 may add (step 184) weights to its edges as follows intersection edges, such as new edge 152, may be given significant weights, discussed in more detail hereinbelow. All other edges may be given an infinite weight.

In one embodiment, weights for intersection edges may be some small constant value. In other embodiments, the weights may reflect any one of the following:

a) the angle between the two faces, where the larger the angle, the larger the weight (this is intended to encourage the cut to happen where the two models have similar local shape);

b) the difference in texture, when texture is available, where the more similar the texture or colors of the two models are at this intersection, the lower the weights;

c) the distance between the faces connected by the intersection edge (when approximate intersections are allowed as discussed hereinbelow); the larger the distance, the higher the weights; or

d) different combinations of the above schemes.

In step 186, unit 74 may cut the weighted graph using the minimal cut method discussed hereinabove, leaving two cut versions of the weighted graph. Since the nodes of the weighted graph represent meshes of the model, the two models may be cut (step 188) by simply taking those faces of each model represented by the nodes of the cut versions associated with the model. Thus, the faces of model A may be those which are represented by the nodes connected to the source and the faces of model B may be those which are represented by the nodes connected to the target.

Subject to the user's requirements, unit 74 may now stitch (step 190) the two cut models to produce a single model. As an additional step, standard smoothing techniques can be used to smooth out the seams.

The combination of the two graphs may be performed (in step 180), in a number of ways. One embodiment may utilize global reasoning and another may utilize local orientation. For the global reasoning embodiment, unit 74 may run a standard breadth-first search on each dual graph, starting at the source (or target) and numbering the nodes of the model by their mesh-distance from the source (or target). Nodes around an intersection edge may be cross-matched. That is, if node v1 has a lower distance value than node ul, and node v2 has a lower value than node u2, then unit 74 may pair node v1 with node u2 (low with high) and node u1 with node v2 (high with low). In the unlikely event of both nodes having identical distance values, an arbitrary decision may be made. We note that the triangulation density can affect the way nodes are connected. Pre-simplification of both graphs can eliminate this problem. An extension of the BFS method would replace mesh distances with geodesic distances. Here, there is no need to simplify the two meshes.

For the local orientation embodiment, unit 74 may connect nodes according to the proximity (the angle) of the faces of each model's mesh (which the nodes represent) That is, connect nodes v1 and v2 if there is an acute angle between the faces they represent. When the angle is exactly 90 degrees, an arbitrary decision may be made. Larger local neighborhoods may be scanned in order to make this decision based, not on the immediate faces bordering the intersection, but also those beyond.

In a further alternative embodiment, unit 74 may allow the models to be connected through approximate intersections. For this embodiment, unit 74 may check, in step 170, not only intersecting faces, but faces which are close to each other, up to some user defined distance value. Given two such neighboring faces, one from each model, unit 74 may add a node to each face, e.g. at its center (triangulating both faces accordingly). Step 172 may proceed as above, but taking an edge of the dual graph, passing through one of the sides of the new face, to also be an intersection edge.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
combining at least two 3-D models, given the relative positions of said models and constraint areas of said models that should not be changed by the combination.

2. The method according to claim 1 and wherein said combining comprises:
generating a weighted graph representation of said models at least in a transition volume defined with respect to said positions and including at least a portion of said constraint areas; and
finding a minimum cut which separates said weighted graph into two cut graphs representing cut versions of said models.

3. The method according to claim 2 and also comprising changing said models to match said graph cut versions of said models.

4. The method according to claim 3 and also comprising stitching said cut models together.

5. The method according to claim 2 and wherein said weighted graph has nodes representing voxels of the volume occupied by said models, edges connecting neighboring said voxels, source and target nodes to which nodes representing voxels of said constraint areas are connected and weights associated with each edge which indicate whether said edge crosses a boundary of one of said models, crosses an intersection of said models or remains within one of said models.

6. The method according to claim 5 and wherein said weights are defined as dist(Aᵢ,Bᵢ) which is defined as follows:
$$dist ( {A}_{i} , {B}_{i} ) = \{ \begin{matrix}1 & i is a boundary voxel \\ \frac{1}{10 k} & i is an intersection voxel \\ \frac{1}{100 n k} & i is an empty voxel\end{matrix} \}$$
where k is the total number of intersection voxels and n is the total number of voxels.

7. The method according to claim 1 and also comprising manual alignment of said two models via a graphical user interface.

8. The method according to claim 1 and also comprising part-in-whole alignment of said two models.

9. The method according to claim 8 and wherein said part-in-whole alignment comprises assigning higher weights to parts to be aligned than to those not to be aligned.

10. The method according to claim 2 and wherein said weighted graph has nodes representing mesh faces of said models, edges at least connecting faces which share sides, intersecting edges connecting nodes representing faces of said models which intersect, source and target nodes to which nodes representing mesh faces of said constraint areas are connected and weights associated with each edge which indicate whether or not said edge is an intersecting edge.

11. A method for composing a single 3D model from two input 3D models, the method comprising:
using minimum cut graph techniques to define a transition between said two models.

12. The method according to claim 11 and wherein said using comprises:
generating a weighted graph representation of said models at least within a user-defined alignment area and including at least a portion of user-defined constraint areas; and
finding a minimum cut which separates said weighted graph into two cut graphs representing cut versions of said models.

13. The method according to claim 12 and also comprising changing said models to match said graph cut versions of said models.

14. The method according to claim 13 and also comprising stitching said cut models together.

15. The method according to claim 12 and wherein said weighted graph has nodes representing voxels of the volume occupied by said models, edges connecting neighboring said voxels, source and target nodes to which nodes representing voxels of said constraint areas are connected and weights associated with each edge which indicate whether said edge crosses a boundary of one of said models, crosses an intersection of said models or remains within one of said models.

16. The method according to claim 15 and wherein said weights are defined as dist(Aᵢ,Bᵢ) which is defined as follows:
$$dist ( {A}_{i} , {B}_{i} ) = \{ \begin{matrix}1 & i is a boundary voxel \\ \frac{1}{10 k} & i is an intersection voxel \\ \frac{1}{100 n k} & i is an empty voxel\end{matrix} \}$$
where k is the total number of intersection voxels and n is the total number of voxels.

17. The method according to claim 12 and wherein said weighted graph has nodes representing mesh faces of said models, edges at least connecting faces which share sides, intersecting edges connecting nodes representing faces of said models which intersect, source and target nodes to which nodes representing mesh faces of said constraint areas are connected and weights associated with each edge which indicate whether or not said edge is an intersecting edge.

18. A method for fixing flaws in a 3D model, the method comprising:
searching in a database for at least a non-flawed portion of another model similar to said input model having a flawed portion;
aligning said non-flawed portion to said flawed portion;
generating constraints from a transition volume around the aligned portions;
generating a weighted graph representation at least of said aligned portions and said constraints; and
replacing said flawed portion with said non-flawed portion, using a minimum cut technique on said graph to define a transition between said portions.

19. The method according to claim 18 and wherein said flaws are broken parts of an object represented by said model.

20. The method according to claim 18 and wherein said flaws are scarred parts of an object represented by said model.

21. The method according to claim 18 and wherein said flaws are missing parts of an object represented by said model.

22. A method for performing piecewise rigid deformation on a 3D model, the method comprising:
cloning at least one part of said model to be deformed;
moving said cloned part to another position;
positioning said moved part with respect to said model;
receiving constraints with respect to said positioned items;
generating a weighted graph representation at least of a transition volume at least of said positioned items; and
creating a new model from said positioned items, using a minimum cut technique on said graph to define a transition between said items.

23. A method for aligning at least two 3D models, the method comprising:
aligning a portion of a first model with a portion of a second model.

24. The method according to claim 23 and wherein said aligning comprises assigning higher weights to said portions than to the remaining parts of said models.

25. Apparatus comprising:
means for receiving at least two 3-D models, their positions and constraint areas of said models that should not be changed by their combination; and
a model composing unit to combine said models, given said positions and said constraint areas.

26. The apparatus according to claim 25 and wherein said model composing unit comprises:
a graph unit to generate a weighted graph representation of said models at least in a transition volume defined with respect to said positions and including at least a portion of said constraint areas; and
a separating unit to find a minimum cut which separates said weighted graph into two cut graphs representing cut versions of said models.

27. The apparatus according to claim 26 and also comprising a cutting unit to change said models to match said graph cut versions of said models.

28. The apparatus according to claim 27 and also comprising a stitcher to stitch said cut models together.

29. The apparatus according to claim 26 and wherein said weighted graph has nodes representing voxels of the volume occupied by said models, edges connecting neighboring said voxels, source and target nodes to which nodes representing voxels of said constraint areas are connected and weights associated with each edge which indicate whether said edge crosses a boundary of one of said models, crosses an intersection of said models or remains within one of said models.

30. The apparatus according to claim 29 and wherein said weights are defined as dist(Aᵢ,Bᵢ) which is defined as follows:
$$dist ( {A}_{i} , {B}_{i} ) = \{ \begin{matrix}1 & i is a boundary voxel \\ \frac{1}{10 k} & i is an intersection voxel \\ \frac{1}{100 n k} & i is an empty voxel\end{matrix} \}$$
where k is the total number of intersection voxels and n is the total number of voxels.

31. The apparatus according to claim 25 and also comprising a user interface to enable manual alignment of said two models via a graphical user interface.

32. The apparatus according to claim 25 and also comprising a part-in-whole aligner to align parts of said two models.

33. The apparatus according to claim 32 and wherein said aligner comprises a weight assigner to assign higher weights to parts to be aligned than to those not to be aligned.

34. The apparatus according to claim 26 and wherein said weighted graph has nodes representing mesh faces of said models, edges at least connecting faces which share sides, intersecting edges connecting nodes representing faces of said models which intersect, source and target nodes to which nodes representing mesh faces of said constraint areas are connected and weights associated with each edge which indicate whether or not said edge is an intersecting edge.

35. Apparatus for composing a single 3D model from two input 3D models, the apparatus comprising:
a graph processor to utilize minimum cut graph techniques to define a transition between said two models.

36. The apparatus according to claim 35 and wherein said graph processor comprises:
a graph unit to generate a weighted graph representation of said models at least within a user-defined alignment area and including at least a portion of user-defined constraint areas; and
a separator to find a minimum cut which separates said weighted graph into two cut graphs representing cut versions of said models.

37. The apparatus according to claim 36 and also comprising a cutting unit to change said models to match said graph cut versions of said models.

38. The apparatus according to claim 37 and also comprising a stitcher to stitch said cut models together.

39. The apparatus according to claim 36 and wherein said weighted graph has nodes representing voxels of the volume occupied by said models, edges connecting neighboring said voxels, source and target nodes to which nodes representing voxels of said constraint areas are connected and weights associated with each edge which indicate whether said edge crosses a boundary of one of said models, crosses an intersection of said models or remains within one of said models.

40. The apparatus according to claim 39 and wherein said weights are defined as dist(Aᵢ,Bᵢ) which is defined as follows:
$$dist ( {A}_{i} , {B}_{i} ) = \{ \begin{matrix}1 & i is a boundary voxel \\ \frac{1}{10 k} & i is an intersection voxel \\ \frac{1}{100 n k} & i is an empty voxel\end{matrix} \}$$
where k is the total number of intersection voxels and n is the total number of voxels.

41. The apparatus according to claim 36 and wherein said weighted graph has nodes representing mesh faces of said models, edges at least connecting faces which share sides, intersecting edges connecting nodes representing faces of said models which intersect, source and target nodes to which nodes representing mesh faces of said constraint areas are connected and weights associated with each edge which indicate whether or not said edge is an intersecting edge.

42. Apparatus for fixing flaws in a 3D model, the apparatus comprising:
a searcher to search in a database for at least a non-flawed portion of another model similar to said input model having a flawed portion;
an aligner to align said non-flawed portion to said flawed portion;
a constraint unit to generate constraints from a transition volume around the aligned portions;
a graph unit to generate a weighted graph representation at least of said aligned portions and said constraints; and
a replacer to replace said flawed portion with said non-flawed portion, using a minimum cut technique on said graph to define a transition between said portions.

43. The apparatus according to claim 42 and wherein said flaws are broken parts of an object represented by said model.

44. The apparatus according to claim 42 and wherein said flaws are scarred parts of an object represented by said model.

45. The apparatus according to claim 42 and wherein said flaws are missing parts of an object represented by said model.

46. Apparatus for performing piecewise rigid deformation on a 3D model, the apparatus comprising:
a cloner to clone at least one part of said model to be deformed;
a model mover to move said cloned part to another position;
a positioner to position said moved part with respect to said model;
a constraint unit to receive with respect to said positioned items;
a graph unit to generate a weighted graph representation at least of a transition volume at least of said positioned items; and
a deformer to create a new model from said positioned items, using a minimum cut technique on said graph to define a transition between said items.

47. Apparatus for aligning at least two 3D models, the apparatus comprising:
means for receiving a first and a second model; and
an part-in-whole aligner to align a portion of a first model with a portion of a second model.

48. The apparatus according to claim 47 and wherein said aligning comprises assigning higher weights to said portions than to the remaining parts of said models.
